(19) United States
(12) Patent Application Publication
(10) Pub. No.: US 2022/0340036 A1
(43) Pub. Date: Oct. 27, 2022

(54) MANAGEMENT METHODS AND SYSTEMS FOR ELECTRIC VEHICLE CHARGING PLATFORM

(71) Applicant: Noodoe Corporation, Taipei City (TW)

(72) Inventors: Yu-Ting Liou, Taipei City (TW); En-Yu Shih, Taipei City (TW); Yin-Ju Chou, Taipei City (TW)

(21) Appl. No.: 17/698,066

(22) Filed: Mar. 18, 2022

(30) Foreign Application Priority Data
Apr. 23, 2021 (TW) 110114786

(51) Int. Cl. B60L 53/66; B60L 53/68; B60L 53/67; B60L 53/65; B60L 53/30; G06Q 30/06

(52) U.S. Cl. CPC B60L 53/665; B60L 53/68; B60L 53/67; B60L 53/65; B60L 53/305; G06Q 30/0645

(57) ABSTRACT

Management methods and systems for electric vehicle (EV) charging platform are provided. First, a server provides a management platform. Then, the server receives login of a corresponding account and input of a usage authority identification code (UAID) through the management platform. The server receives an EV charging station ID of an EV charging station through management platform to register the EV charging station in management platform. After the EV charging station is registered, the server receives at least one charging information from the EV charging station and determines whether the UAID is a first type ID or a second type ID, wherein a first set of management functions of management platform is provided to the account for the first type ID while a second set of management functions with fewer management functions than the first set is provided to the account for the second type ID.

### BACKGROUND OF THE INVENTION

### Field of the Invention

The disclosure relates generally to management methods and systems, and, more particularly to management methods and systems for electric vehicle charging platforms.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Currently, after the installation of a newly installed charging station is completed, it still needs to go through a series of setting procedures to set up this charging station and takes a period of time to wait for the setting to take effect before the relevant services can be opened. If the charging station operator does not complete the entire setup process, it will not be able to start the charging operation of the corresponding charging station and manage the corresponding charging station, causing great trouble for the operator of the charging station.

### BRIEF SUMMARY OF THE INVENTION

In a management method for an electric vehicle charging platform for use in a server connected with at least one electric vehicle charging station via a network, a management platform is first provided by the server. Next, the server receives a login of a corresponding account and an input of a usage authority identification code through the management platform. Then, the server receives an electric vehicle charging station identification code corresponding to the electric vehicle charging station through the management platform to register the electric vehicle charging station in the management platform, wherein the server receives at least one charging information from the electric vehicle charging station through the network after the electric vehicle charging station is registered in the management platform and determines whether the usage authority identification code is a first type identification code or a second type identification code. When the usage authority identification code is the first type identification code, the server provides a first set of a plurality of management functions of the management platform to the account. When the usage authority identification code is the second type identification code, the server provides a second set of management functions of the management platform to the account, wherein the number of the management functions of the second set is less than that of the first set.

An embodiment of a management system for an electric vehicle charging platform comprises at least one electric vehicle charging station, and a server. The server is connected to the electric vehicle charging station via a network. The server provides a management platform, receives a login of a corresponding account and an input of a usage authority identification code through the management platform, receives an electric vehicle charging station identification code corresponding to the electric vehicle charging station through the management platform to register the electric vehicle charging station in the management platform, wherein the server receives at least one charging information from the electric vehicle charging station through the network after the electric vehicle charging station is registered in the management platform. The server determines whether the usage authority identification code is a first type identification code or a second type identification code, provides a first set of a plurality of management functions of the management platform to the account when the usage authority identification code is the first type identification code, and provides a second set of management functions of the management platform to the account when the usage authority identification code is the second type identification code, wherein the number of the management functions of the second set is less than that of the first set.

In some embodiments, when the usage authority identification code is the first type identification code, the server determines whether the account has completed a setting of a corresponding financial account in the management platform, provides the first set of the management functions to the account when the setting of the corresponding financial account is completed, and suspends the providing operation that provides the first set of the management functions to the account when the setting of the corresponding financial account is not completed.

In some embodiments, the server further periodically deducts a corresponding management fee based on the financial account.

In some embodiments, the server generates an upgrade option for the account to prompt the account to perform a setting of a corresponding financial account when the use authorization identification code is the second type identification code, provides the first set of the management functions to the account when the setting of the corresponding financial account is completed, and periodically deducts a corresponding management fee based on the financial account

In some embodiments, the server receives a charging request corresponding to the electric vehicle charging station, transmits a signal to the electric vehicle charging station through the network to perform a charging operation in response to the charging request, performs a billing operation corresponding to the charging operation to obtain a charging fee corresponding to the charging operation, and provides at least a part of the charging fee to the account according to the financial account.

Management methods for electric vehicle charging platforms may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a management system for an electric vehicle charging platform of the invention;

FIG. 2 is a schematic diagram illustrating an embodiment of an electric vehicle charging station of the invention;

FIG. 3 is a schematic diagram illustrating an embodiment of a server of the invention;

FIG. 4 is a schematic diagram illustrating an embodiment of a mobile device of the invention;

FIG. 5 is a flowchart of an embodiment of a management method for an electric vehicle charging platform of the invention;

FIG. 6 is a flowchart of another embodiment of a management method for an electric vehicle charging platform of the invention;

FIG. 7 is a flowchart of yet another embodiment of a management method for an electric vehicle charging platform of the invention; and

FIG. 8 is a flowchart of another embodiment of a management method for an electric vehicle charging platform of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

FIG. 1 is a schematic diagram illustrating an embodiment of a management system for an electric vehicle charging platform of the invention. The management system for electric vehicle charging platforms 100 comprises a plurality of electric vehicle charging stations, such as the electric vehicle charging stations 112 and 114, and a server 130 respectively connected with the respective electric vehicle charging stations via a network 120. The respective charging stations can provide electric vehicles (EV1, EV2) for charging operations. In some embodiments, the network 120 may be a wired network, a telecommunication network, and a wireless network, such as a Wi-Fi network. The server 130 can receive various data from the respective electric vehicle charging stations (112, 114) via the network 120, and transmit related signals to the respective electric vehicle charging stations (112, 114). The respective electric vehicle charging stations (112, 114) can perform related operations according to the signals received from the server 130. For example, when the electric vehicle EV1 is coupled to the electric vehicle charging station 112 through a charging gun of the electric vehicle charging station 112 for a charging operation, the electric vehicle charging station 112 can continuously transmit charging information corresponding the charging operation of the electric vehicle EV1 via the network 120, and the server 130 can receive the charging information of the corresponding charging operation from the electric vehicle charging station 112 via the network 120. Similarly, when the electric vehicle EV2 is coupled to the electric vehicle charging station 114 through a charging gun of the electric vehicle charging station 114 to perform a charging operation, the electric vehicle charging station 114 can continuously transmit the charging information corresponding the charging operation of the electric vehicle EV2 via the network 120, and the server 130 can receive the charging information of the corresponding charging operation from the electric vehicle charging station 114 via the network 120. The server 130 can provide a management platform, wherein the management platform includes a plurality of corresponding management functions, and specific electric vehicle charging stations, such as the respective electric vehicle charging stations (112, 114), can be set and managed through the management functions of the management platform. In some embodiments, the management platform can provide a user interface, and the user can use the user interface to perform respective operations such as an account login operation, a use authority identification code input operation and so on. It should be noted that, in some embodiments, the management functions of the management platform may have a first set and a second set in which the first set may include all the management functions of the management platform, and the second set may only include part of the management functions of the management platform. For example, in one embodiment, when the management functions include at least one first function, the first set includes the first function while the second set does not include the first function. In another embodiment, the management functions may include basic management functions and advanced management functions, wherein the second set includes only basic management functions, and the first set includes both basic management functions and advanced management functions.

It is noted that the user can connect the electric vehicle EV1 and the electric vehicle charging station 112 to each other, such as inserting a charging gun into the charging port of the electric vehicle to send a charging request corresponding to the electric vehicle charging station 112 to use the electric vehicle charging station 112. The electric vehicle charging station 112 performs a charging operation for the electric vehicle EV1. Similarly, the user can connect the electric vehicle EV2 and the electric vehicle charging station 114 to each other, such as inserting a charging gun into the charging port of the electric vehicle to send a charging request corresponding to the electric vehicle charging station 114 to use the electric vehicle charging station 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the electric vehicle charging station 112 via the network 120, so that the electric vehicle charging station 112 outputs power to the electric vehicle EV1, such as an electric scooter or an electric car, which is electrically connected to it, or prohibits the electric vehicle charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the electric vehicle charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use a physical sensing card, such as an RFID card to approach an induction area (not shown in FIG. 1) on the electric vehicle charging station 112 to generate a corresponding charging request, and sent it to the server 130 via the network 120. It is reminded that, in some embodiments, each user can have an RFID card.

It is noted that, the mobile device 140 corresponding to the owner of the electric vehicle can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

It is understood that, in some embodiments, the server 130 can perform a load adjustment operation for the electric vehicle charging stations. Specifically, the server 130 can generate an instruction and send the instruction to the charging station (112, 114) via the network 120 to control the charging station to output power for charging with a specified power parameter, such as a specified amperage, during a specific period of time to the electric vehicle connected to the station, or to prohibit the charging station from outputting power to the electric vehicle.

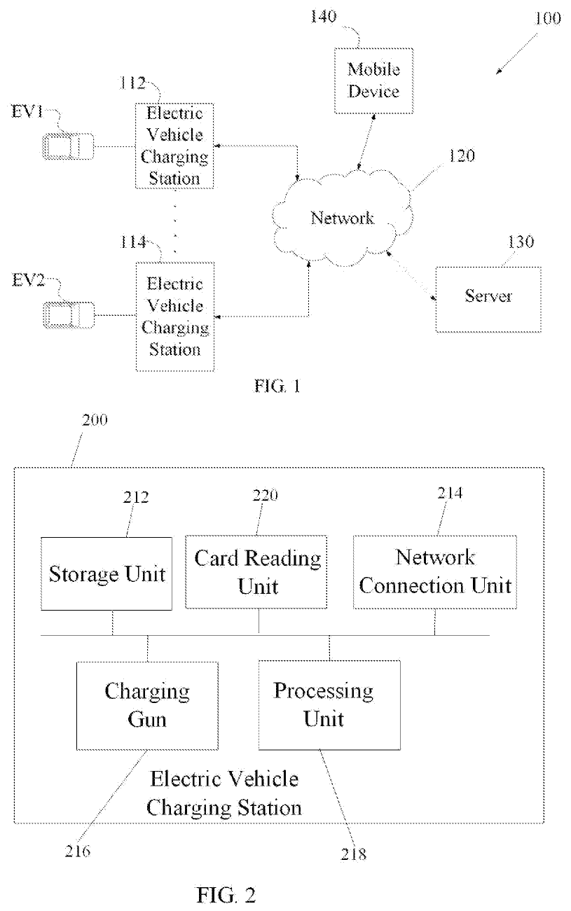

FIG. 2 is a schematic diagram illustrating an embodiment of an electric vehicle charging station of the invention. The electric vehicle charging station 200 shown in FIG. 2 can be applied to the electric vehicle charging stations (112, 114) in FIG. 1, which has processing and computing capabilities to perform charging management operations for the electric vehicle charging station 200. The electric vehicle charging station 200 has a network connection capability to receive, download or update various parameters and information required for charging management calculations.

The electric vehicle charging station 200 at least comprises a storage unit 212, a network connection unit 214, a charging gun 216, a processing unit 218, and a card reading unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200, and cooperate with the server 130 to execute the management methods for electric vehicle charging platforms of the invention. Related details will be described later. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited to this. In one embodiment, the processing unit 216 may use the network connection unit 214 to transmit the power state of the corresponding electric vehicle through a network for a cloud management server, such as the cloud server 130, for subsequent charging management. In another embodiment, the processing unit 216 can obtain the power parameter of a charging operation from the server 130, determine the output power according to the power parameter received from the server 130, and output the power to at least one electric vehicle through the charging gun 216 to perform the charging operation. The card reading unit 220 may be an RFID reading unit for sensing information of a physical sensing card, such as an RFID card. The information may be a card ID code corresponding to the physical sensing card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

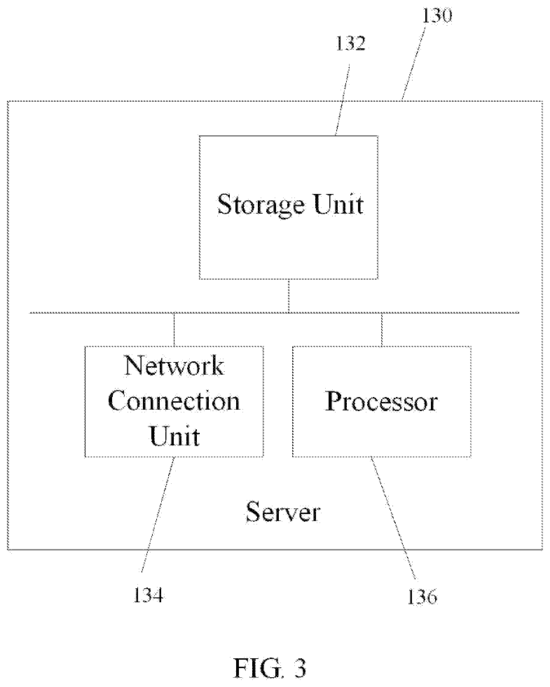

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging stations in a charging field. The server 130 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 may be a memory, which can store and record related data, such as various data of the electric vehicle charging stations. It is noted that, the storage unit 132 may include a management platform, wherein the management platform includes a plurality of corresponding management functions, and specific electric vehicle charging stations can be set and managed through the management functions of the management platform. In some embodiments, the management platform can provide a user interface, and the user can use the user interface to perform respective operations such as an account login operation, a use authority identification code input operation and so on. It should be noted that, in some embodiments, the management functions of the management platform may have a first set and a second set in which the first set may include all the management functions of the management platform, and the second set may only include part of the management functions of the management platform. For example, in one embodiment, when the management functions include at least one first function, the first set includes the first function while the second set does not include the first function. In another embodiment, the management functions may include basic management functions and advanced management functions, wherein the second set includes only basic management functions, and the first set includes both basic management functions and advanced management functions. For example, in one embodiment, the advanced management function may include at least one energy load management function and/or one demand response function. In another embodiment, the advanced management function may include a charging rate setting function while the basic management function does not include the charging rate setting function. It should be noted that the aforementioned information is only example, and the invention is not limited thereto. Any sets of different combination of management functions can also be applied to the present invention.

Through the network connection unit 134, the server 130 can be coupled to and communicates with the electric vehicle charging stations (112, 114) via the network 120, such as a wired network, a telecommunications network, and a wireless network, such as a Wi-Fi network, and transmits related data/signals/commands to different electric vehicle charging stations via the network 120 to control whether the electric vehicle charging stations output power, and specify power parameters for outputting power to electric vehicles. The processor 136 can control the operations of related software and hardware in the server 130, and execute the management methods for electric vehicle charging platforms of the invention. The relevant details will be described later. It is understood that, in some embodiments, the processor 136 may be a general-purpose controller, a Micro-Control Unit, MCU, or a Digital Signal Processor, DSP, etc., to provide data analysis, processing, and calculation functions.

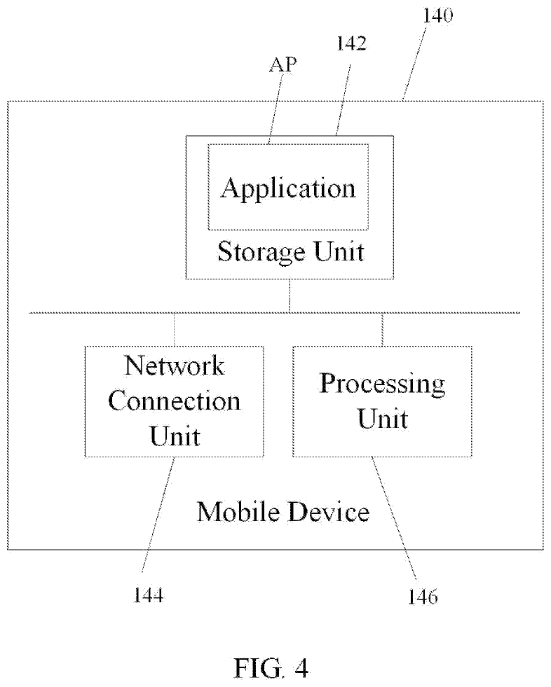

FIG. 4 is a schematic diagram illustrating an embodiment of a mobile device of the invention. As shown in FIG. 4, the mobile device 140 according to the embodiment of the present invention can be any electronic device capable of Internet access, such as mobile phones, smart phones, personal digital assistants, global positioning systems, and notebook computers. The mobile device 140 at least comprises a storage unit 142, a network connection unit 144, and a processing unit 146. The storage unit 142, such as a memory, can store and record related data, such as a user ID code corresponding to a user of the corresponding mobile device, and related data such as charging status information and notifications received from the server 130 via the network 120. In some embodiments, the status information and notification may include notifying that the electric vehicle has stopped charging, notifying that the vehicle is being moved, and/or notifying that the charging gun of the electric vehicle charging device has been disconnected from the electric vehicle, etc. It is reminded that, the storage unit 142 may include an application AP. The application AP is used for charging operations. The application AP may include a user interface, and through which a charging request can be generated for a specific electric vehicle charging station. In addition, the application AP may have a scanning function for scanning a two-dimensional identification code, such as a QR code on a specific electric vehicle charging station to generate the above-mentioned charging request, thereby starting a charging process. In addition, the scanning function of the application AP can also scan the identification data on the physical sensing card to obtain the identity identification data of the corresponding user. The details will be explained later. Through the network connection unit 144, the mobile device 140 can be coupled to and communicate with the server 130 via the network 120, such as a wired network, a telecommunication network, and a wireless network, such as a Wi-Fi network. The processor 146 can control the operations of related software and hardware in the mobile device 140, and cooperate with the implementation of the management methods for electric vehicle charging platforms of the present invention. The relevant details will be described later. It is noted that, in some embodiments, the processor 146 may be a general-purpose controller, a microcontroller (Micro-Control Unit, MCU), or a digital signal controller (Digital Signal Processor, DSP), etc., to provide the functions of data analysis, processing and calculation, but the invention is not limited thereto.

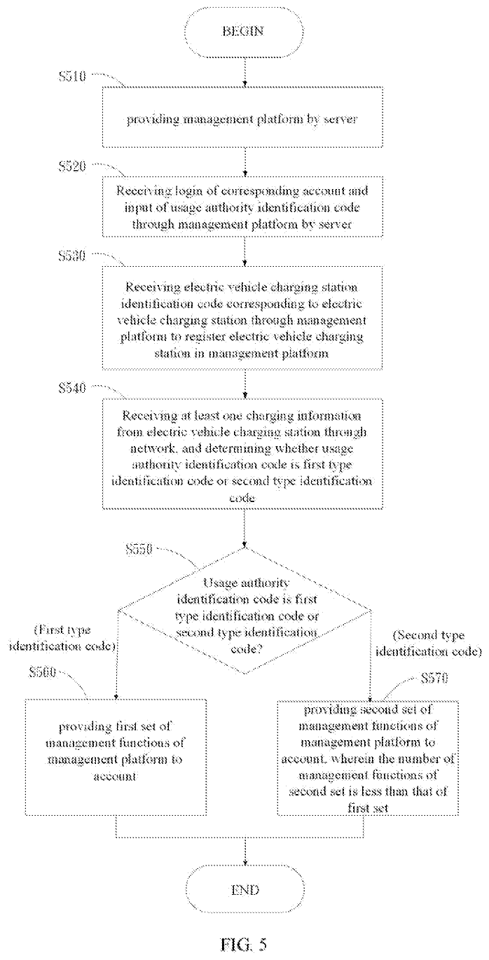

FIG. 5 is a flowchart of an embodiment of a management method for an electric vehicle charging platform of the invention. The management method for the electric vehicle charging platform of the invention can be used in a server and at least one electric vehicle charging station coupled with the server via a network.

First, in step S510, a management platform is provided by the server. The management platform has multiple management functions, and specific electric vehicle charging stations can be set and managed through the management functions of the management platform. It is to be noted that, in some embodiments, the management platform may provide a user interface, and the user may use the user interface to perform operations, such as an account login operation, a usage authority identification code input operation and so on. Next, in step S520, the server receives the login of a corresponding account and the input of a usage authority identification code through the management platform. After receiving the login of the corresponding account and the input of the usage authority identification code, in step S530, the server receives a charging station identification code of a corresponding electric vehicle charging station through the management platform to register the electric vehicle charging station in the management platform. It is reminded that, the server can bind the charging station identification code of the corresponding electric vehicle charging station with the account, so as to register the electric vehicle charging station in the management platform. In other words, the server will record the charging station identification code of the corresponding electric vehicle charging station and set the owner of the corresponding account as the owner of the electric vehicle charging station. After the electric vehicle charging station is registered in the management platform, in step S540, the server receives at least one charging information from the electric vehicle charging station through the network, and determines whether the usage authority identification code is a first type identification code or a second type identification code. It is noted that, after the electric vehicle charging station is registered on the management platform, the electric vehicle charging station can continue to transmit the charging information of the corresponding electric vehicle charging operation through the network, and the server can receive the charging information of the corresponding electric vehicle charging operation through the network. In some embodiments, the charging information may include the battery status of the corresponding electric vehicle, the time elapsed during the charging operation, the amount of power received by the electric vehicle during the charging operation, etc., but the invention is not limited thereto. It is reminded that, in some embodiments, the usage authority identification code can be divided into a first type identification code and a second type identification code, which and each corresponds to a different account type, and the server can determine the account type of the corresponding account by using the usage authority identification code. When the usage authority identification code is the first type identification code (“First type identification code” in step S550), in step S560, the server provides a first set of management functions of the management platform to the account. When the usage authority identification code is the second type identification code (“Second type identification code” in step S550), in step S570, the server provides a second set of management functions of the management platform to the account, wherein the number of management functions in the second set is less than the number of management functions in the first set. It should be noted that, in some embodiments, the first set may include all of the management functions of the management platform while the second set may include only part of the management functions of the management platform. For example, in one embodiment, when the management functions include at least one first function, the first set includes the first function while the second set does not include the first function. In another embodiment, the management functions may include basic management functions and advanced management functions, wherein the second set includes only basic management functions, and the first set includes both basic management functions and advanced management functions. For example, in one embodiment, the advanced management function includes at least an energy load management function and/or a demand response function. In another embodiment, the advanced management function includes a charging rate setting function, while the basic management function does not include the charging rate setting function. In other words, the account whose usage authority identification code is the second type identification code can only provide free charging, and the account whose usage authority identification code is the first type identification code can charge the charging fee for the corresponding charging operation. It should be noted that the aforementioned data are only examples, and the present invention is not limited thereto. Any management function set with different combination can be applied to the present invention. In other words, a user can quickly register a newly added electric vehicle charging station through the management platform, and the server can identify the usage authority of the account according to the input usage authority identification code, so as to determine the management functions that can be used and/or displayed in the management platform, wherein different usage authority identification codes have different set of management functions of the management platform. In some embodiments, the management platform may include a first interface having a first set of management functions and a second interface having a second set of management functions, and the server provides the management platform with the first interface to the account when the usage authority identification code is the first type identification code, while the server provides the management platform with the second interface to the account when the usage authority identification code is the second type identification code. In other words, accounts with different usage authority identification codes will see different management functions displayed on the management platforms.

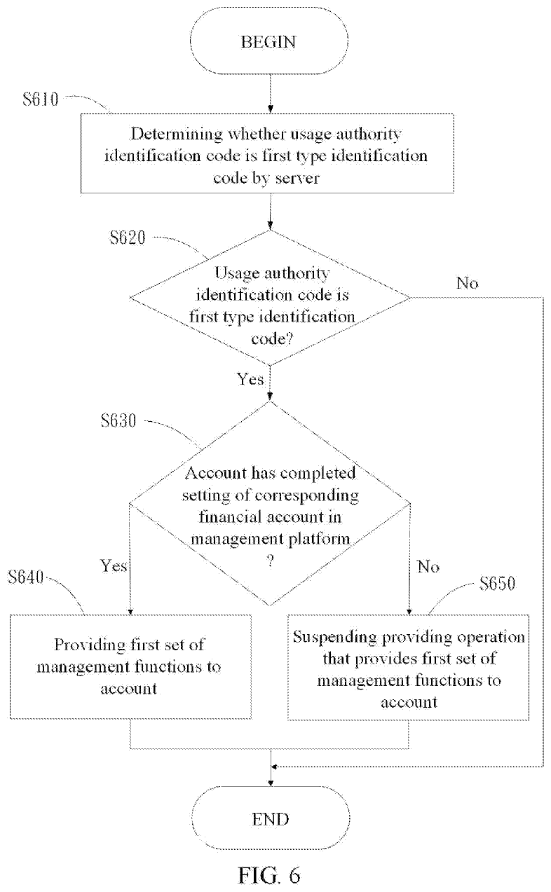

FIG. 6 is a flowchart of another embodiment of a management method for an electric vehicle charging platform of the invention. The management method for the electric vehicle charging platform of the invention can be used in a server and at least one electric vehicle charging station coupled with the server via a network. In this embodiment, the account of the first type identification code needs to complete the setting of the payment account before providing the corresponding management functions.

First, in step S610, the server determines whether the usage authority identification code is the first type identification code. As mentioned above, the server can receive at least one charging information from the electric vehicle charging station through the network and determine whether the usage authority identification code is the first type identification code therefrom. When the usage authority identification code is not the first type identification code (No in step S620), the process ends. When the usage authority identification code is the first type identification code (Yes in step S620), in step S630, the server then determines whether the account has completed the setting of a corresponding financial account on the management platform. When the setting of the corresponding financial account is completed (Yes in step S630), in step S640, the server provides the first set of management functions to the account. When the setting of the corresponding financial account is not completed (No in step S630), in step S650, the server suspends providing the first set of management functions to the account. In other words, when the usage authority identification code of the account is the first type identification code and the setting of the corresponding financial account has been completed on the management platform, the server can assign the first set of management functions to the account. When the usage authority identification code of the account is the first type identification code and the setting of the corresponding financial account has not been completed on the management platform, the server may suspend providing the first set of management functions to the account. It is noted that, in some embodiments, when the setting of the corresponding financial account is not completed in step S650, the server may also provide a second set of management functions to the account, wherein the number of the management functions within the second set is less than that within the first set. Later, after the setting of the corresponding financial account is completed, the server provides the first set of management functions to the account. In some embodiments, once the setting of the corresponding financial account has been completed, the server can periodically perform a deduction operation of a corresponding management fee based on the financial account.

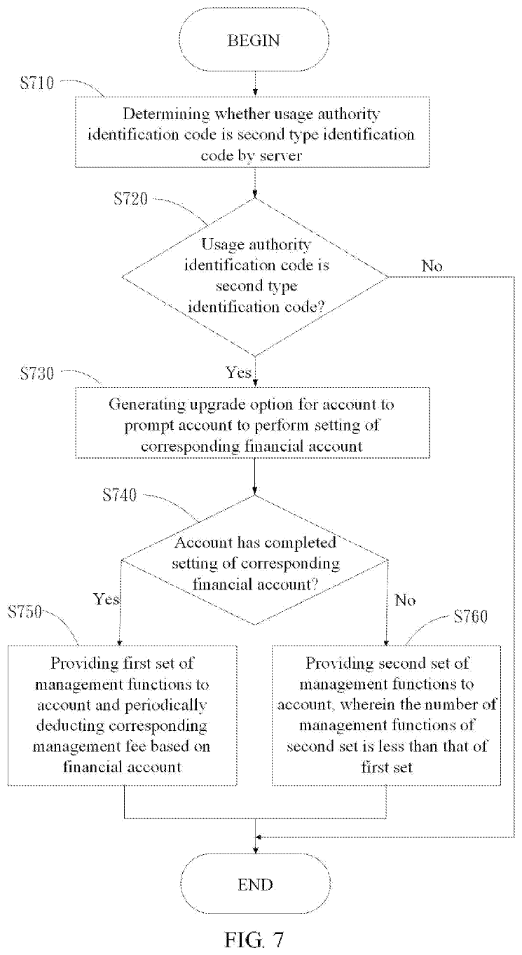

FIG. 7 is a flowchart of yet another embodiment of a management method for an electric vehicle charging platform of the invention. The management method for the electric vehicle charging platform of the invention can be used in a server and at least one electric vehicle charging station coupled with the server via a network. In this embodiment, an upgrade option can be provided for users with an account of the second type identification code to upgrade their management platforms from a basic version of the management platform with fewer management functions to a full version of the management platform with more management functions.

First, in step S710, the server receives at least one charging information from the electric vehicle charging station through the network, and determines whether the usage authority identification code is the second type identification code. As aforementioned, the server can receive at least one charging information from the electric vehicle charging station through the network and determine whether the usage authority identification code is the second type identification code therefrom. When the usage authority identification code is not the second type identification code (No in step S720), the process ends. When the usage authority identification code is the second type identification code (Yes in step S720), in step S730, the server generates an upgrade option for the account to prompt the account to set a corresponding financial account. It is understood that, in some embodiments, the server can generate upgrade options by using the user interface of the management platform for the user to configure the corresponding financial account. The user of a specific account can complete the settings of the corresponding financial account through the upgrade option to upgrade the specific account from a normal account to an advanced account. Next, in step S740, the server determines whether the account has completed the setting of the corresponding financial account. When the setting of the corresponding financial account is completed (Yes in step S740), in step S750, it means that the account has been upgraded to an advanced account, and the server provides the first set of management functions to the account, and periodically perform a deduction operation of a corresponding management fee based on the financial account. In other words, users who upgrade their accounts through the upgrade option can pay a fixed management fee to use the management platform of the first set of management functions with more management functions. When the setting of the corresponding financial account is not completed (No in step S740), in step S760, it means that the account has not been upgraded to an advanced account, and the server provides the second set of management functions to the account. In other words, users who have not upgraded their accounts through the upgrade option can only use the management platform of the second set of management functions with limited management functions and more functional restrictions.

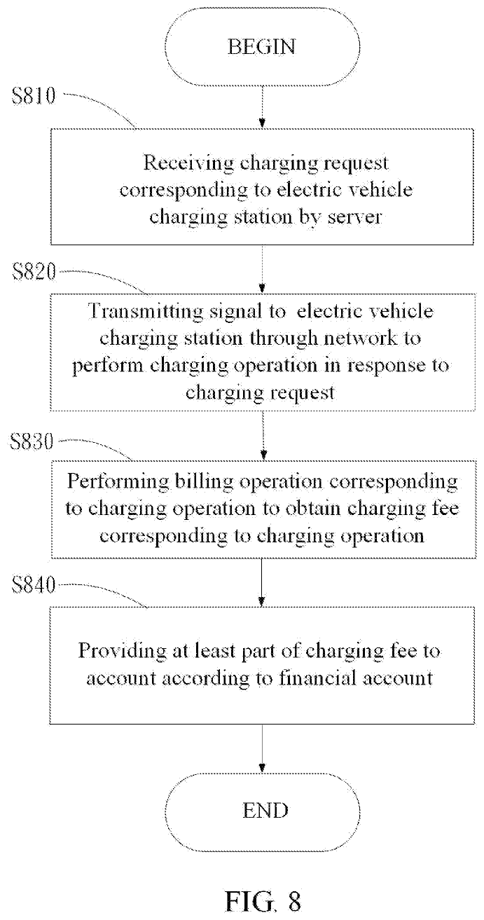

FIG. 8 is a flowchart of still another embodiment of a management method for an electric vehicle charging platform of the invention. The management method for the electric vehicle charging platform of the invention can be used in a mobile device, a server, and at least one electric vehicle charging station coupled with the server via a network. In this embodiment, a specific account of the corresponding electric vehicle charging station can sign a profit-sharing contract and set up a specific financial account in advance, and the system can provide a profit-sharing mechanism to rebate a portion of the charging fee of each charging operation to the specific account according to a specific profit-sharing ratio.

First, in step S810, the server receives a charging request corresponding to the electric vehicle charging station. It should be noted that, in some embodiments, the user can connect an electric vehicle EV1 and a first charging station to each other, such as inserting a charging gun into the charging port of the electric vehicle, to send a charging request corresponding to the first charging station. In some embodiments, the server may directly or indirectly receive a charging request from the mobile device of the owner of the electric vehicle EV1. It is reminded that, in some embodiments, the user can scan a Quick Response Code (QR code) on the electric vehicle charging station through a scanning function of the application in the mobile device to generate the charging request. In some embodiments, the user can select the first charging station by using an application in the mobile device, and execute an activation function, so as to generate the above-mentioned charging request. In some embodiments, the owner of the electric vehicle EV1 can use an RFID card to approach an induction area on the first charging station to generate a corresponding charging request. In step S820, in response to the charging request, the server transmits a signal to the electric vehicle charging station through the network to perform a charging operation, and in step S830, it performs a billing operation corresponding to the charging operation to obtain a charging fee for the corresponding charging operation. After obtaining the charging fee corresponding to the charging operation, then, in step S840, the server provides at least a portion of the charging fee to the account according to the financial account. In other words, the server may provide the corresponding charging fee to the financial account of the account of the corresponding electric vehicle charging station according to the profit-sharing ratio corresponding to the profit-sharing contract. In some embodiments, the profit-sharing ratio may be a fixed amount charged for each charging fee, such as each charging fee charges NT 10 dollars. In some embodiments, the profit-sharing ratio is expressed as a percentage. For example, in one embodiment, the profit-sharing ratio is set to 50%, and when the charging fee for the corresponding charging operation is NT 100 dollars, the server can provide NT 50 dollars to the financial account of the corresponding electric vehicle charging station, but the present invention is not limited thereto.

Therefore, the management systems and methods for electric vehicle charging platforms of the present invention can quickly register and bind the accounts of electric vehicle charging stations through the management platform, and different accounts with different usage rights can be provided to correspond to different management functions of the management platform to facilitate the management of the electric vehicle charging station for the user, thereby increasing the efficiency and flexibility of using and managing the electric vehicle charging stations.

Management methods for electric vehicle charging platforms, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A management method for an electric vehicle charging platform for use in a server connected with at least one electric vehicle charging station via a network, comprising:
providing a management platform by the server;
receiving a login of a corresponding account and an input of a usage authority identification code through the management platform by the server;
receiving an electric vehicle charging station identification code corresponding to the electric vehicle charging station through the management platform to register the electric vehicle charging station in the management platform by the server, wherein the server receives at least one charging information from the electric vehicle charging station through the network after the electric vehicle charging station is registered in the management platform;
determining whether the usage authority identification code is a first type identification code or a second type identification code;
when the usage authority identification code is the first type identification code, providing a first set of a plurality of management functions of the management platform to the account; and
when the usage authority identification code is the second type identification code, providing a second set of management functions of the management platform to the account, wherein the number of the management functions of the second set are less than that of the first set.

2. The method of claim 1, further comprising:
determining whether the account has completed a setting of a corresponding financial account in the management platform when the usage authority identification code is the first type identification code;
providing the first set of the management functions to the account when the setting of the corresponding financial account is completed; and
suspending the providing operation that provides the first set of the management functions to the account when the setting of the corresponding financial account is not completed.

3. The method of claim 2, further comprises periodically perform a deduction operation of a corresponding management fee based on the financial account.

4. The method of claim 2, further comprising:
receiving a charging request corresponding to the electric vehicle charging station;
transmitting a signal to the electric vehicle charging station through the network to perform a charging operation in response to the charging request;
performing a billing operation corresponding to the charging operation to obtain a charging fee corresponding to the charging operation; and
providing at least a part of the charging fee to the account according to the financial account.

5. The method of claim 1, further comprising:
generating an upgrade option for the account to prompt the account to perform a setting of a corresponding financial account when the use authorization identification code is the second type identification code;
providing the first set of the management functions to the account when the setting of the corresponding financial account is completed; and
periodically deducting a corresponding management fee based on the financial account.

6. A management system for an electric vehicle charging platform, comprising:
at least one electric vehicle charging station; and
a server connected to the electric vehicle charging station via a network, providing a management platform, receiving a login of a corresponding account and an input of a usage authority identification code through the management platform, receiving an electric vehicle charging station identification code corresponding to the electric vehicle charging station through the management platform to register the electric vehicle charging station in the management platform, wherein the server receives at least one charging information from the electric vehicle charging station through the network after the electric vehicle charging station is registered in the management platform, determining whether the usage authority identification code is a first type identification code or a second type identification code, providing a first set of a plurality of management functions of the management platform to the account when the usage authority identification code is the first type identification code, and providing a second set of management functions of the management platform to the account when the usage authority identification code is the second type identification code, wherein the number of the management functions of the second set are less than that of the first set.

7. The system of claim 6, wherein the server further determines whether the account has completed a setting of a corresponding financial account in the management platform when the usage authority identification code is the first type identification code, provides the first set of the management functions to the account when the setting of the corresponding financial account is completed, and suspends the providing operation that provides the first set of the management functions to the account when the setting of the corresponding financial account is not completed.

8. The system of claim 7, wherein the server further periodically performs a deduction operation of a corresponding management fee based on the financial account.

9. The system of claim 7, wherein the server further receives a charging request corresponding to the electric vehicle charging station, transmits a signal to the electric vehicle charging station through the network to perform a charging operation in response to the charging request, performs a billing operation corresponding to the charging operation to obtain a charging fee corresponding to the charging operation, and provides at least a part of the charging fee to the account according to the financial account.

10. The system of claim 6, wherein the server further generates an upgrade option for the account to prompt the account to perform a setting of a corresponding financial account when the use authorization identification code is the second type identification code, and when the setting of the corresponding financial account is completed, the server provides the first set of the management functions to the account and periodically deducts a corresponding management fee based on the financial account.

11. A machine-readable storage medium comprising a computer program, which, when executed, causes a device to perform A management method for an electric vehicle charging platform for use in a server connected with at least one electric vehicle charging station via a network, wherein the method comprises:
providing a management platform by the server;
receiving a login of a corresponding account and an input of a usage authority identification code through the management platform by the server;
receiving an electric vehicle charging station identification code corresponding to the electric vehicle charging station through the management platform to register the electric vehicle charging station in the management platform by the server, wherein the server receives at least one charging information from the electric vehicle charging station through the network after the electric vehicle charging station is registered in the management platform;
determining whether the usage authority identification code is a first type identification code or a second type identification code;
when the usage authority identification code is the first type identification code, providing a first set of a plurality of management functions of the management platform to the account; and
when the usage authority identification code is the second type identification code, providing a second set of management functions of the management platform to the account, wherein the number of the management functions of the second set are less than that of the first set.
